(19) United States
(12) Patent Application Publication
(10) Pub. No.: US 2007/0259644 A1
(43) Pub. Date: Nov. 8, 2007

(54) METHOD AND SYSTEM FOR POWERLINE LOCAL AREA NETWORKS OVER COAXIAL CABLE

(75) Inventors: Tat Keung Chan, South San Francisco, CA (US); Sonly Mu, Salida, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Asoka USA Corporation, Foster City, CA (US)

(21) Appl. No.: 11/689,463

(22) Filed: Mar. 21, 2007

Related U.S. Application Data
(60) Provisional application No. 60/784,715, filed on Mar. 21, 2006.

(51) Int. Cl. H04M 9/00

(52) U.S. Cl. 455/402; 370/485

(57) ABSTRACT

Method and system for powerline local area network over coaxial cable. According to an embodiment, the present invention provides a powerline communication system. The system includes a data connection that is configured to communicating a first signal in a first format. The data connection includes an input/output port. The system also includes a powerline module coupled to the input/output port of the data connection. The powerline module has a data port. The powerline module is configured to convert the first signal in the first format into a second signal into a second format. The first format is different from the second format. The system additionally includes an analog front end device that coupled to the dataport of the powerline module. The analog front end device is configured to condition the second signal for transmission over one or more powerline and/or one or more coaxial cables. Furthermore, the system includes a coupler device coupled to the analog front end device.

### CROSS-REFERENCES TO RELATED APPLICATIONS

This application claims priority to U.S. Provisional Application No. 60/784,715, filed Mar. 21, 2006, which is commonly assigned and incorporated by reference herein for all purposes. In addition, this application is related to the U.S. patent application Ser. No. 11/245,700, filed Oct. 7, 2005, commonly assigned, and which is hereby incorporated by reference.

### BACKGROUND OF THE INVENTION

The present invention relates generally to power line networking techniques. More particularly, the invention provides a method and apparatus for power line communications or the like. Merely by way of example, the invention has been applied to a network structure that includes powerline local network over coaxial cable, but it would be recognized that other applications exist. The other applications may include any other that may have multiple power supply panels and powerline-to-coaxial interfaces, which are operable in regions with selected regions of use, e.g., apartment, hotel, office, hospital, plant.

Telecommunication techniques have been around for numerous years. In the early days, a communication technique known as telegraph was developed. Telegraph generally transferred information from one geographical location to another geographical location using electrical signals in the form of “dots” and “dashes” over transmission lines. An example of commonly used electrical signals is Morse code. Telegraph has been, for the most part, replaced by telephone. The telephone was invented by Alexander Graham Bell in the 1800s to transmit and send voice information using electrical analog signals over a telephone line, or more commonly a single twisted pair copper line. Most industrialized countries today rely heavily upon telephone to facilitate communication between businesses and people, in general.

In the 1990s, another significant development in the telecommunication industry occurred. People began communicating to each other by way of computers, which are coupled to the telephone lines or telephone network or other communication network. These computers or workstations coupled to each other can transmit many types of information from one geographical location to another geographical location. In general, there have been various types of computer networks, including local area networks, commonly called LANs, and wide are networks, commonly called WANs.

Local area networks have been used to connect computers in a smaller geographic region than wide area networks. Most local area networks rely upon dedicated cables to transmit the communication signals through the network. An alternative way of transmitting such communication signals through non-dedicated cables but through a power supply network is referred to as Powerline Communication, commonly called PLC. Powerline communication relies upon pre-existing powerlines that are used to supply electrical power distributed through buildings, such as homes and office structures. Conventional PLC relies upon radio frequency technologies. Although powerline communications have been successful in part, many limitations still exist.

For example, power line communication generally has limited capability due to lack of infrastructure. That is, power line networking has not been “mainstream,” Power line networking has little or almost no infrastructure. Additionally, power line network devices are lacking and simply do not exist on a wide scale. In conventional office settings in the United States, power line networking is absent and almost non-existent. Furthermore, power line communication has been often incompatible with other types of technologies, such as cable, wireless, and others. These and other limitations have been described throughout the present specification and more particularly below.

From the above, it is seen that improved techniques for powerline networks are highly desired.

### BRIEF SUMMARY OF THE INVENTION

The present invention relates generally to power line networking techniques. More particularly, the invention provides a method and apparatus for power line communications or the like. Merely by way of example, the invention has been applied to a network structure that includes powerline local network over coaxial cable, but it would be recognized that other applications exist. The other applications may include any other that may have multiple power supply panels and powerline-to-coaxial interfaces, which are operable in regions with selected regions of use, e.g., apartment, hotel, office, hospital, plant.

According to an embodiment, the present invention provides a powerline communication system. The system includes a data connection that is configured to communicating a first signal in a first format. The data connection includes an input/output port. The system also includes a powerline module coupled to the input/output port of the data connection. The powerline module has a data port. The powerline module is configured to convert the first signal in the first format into a second signal into a second format. The first format is different from the second format. The system additionally includes an analog front end device that coupled to the dataport of the powerline module. The analog front end device is configured to condition the second signal for transmission over one or more powerline and/or one or more coaxial cables. Furthermore, the system includes a coupler device coupled to the analog front end device. The coupler device is configured for coupling at a frequency of about 4 MHz to about 21 MHz. The system also includes a first powerline network that includes substantially one or more powerlines. The first powerline network is coupled to the analog front end device using the coupler device. The set of the powerlines is capable of transmitting power having a voltage ranging from about 100 volts to 240 volts. The first powerline network is adapted to transmit the second signal in an OFDM signal format. The system further includes a coax cable free from a television signal coupled to the analog front end device using the coupler device. For example, the coax cable is adopted to transmit the second signal in an OFDM signal format at a data rate of about 200 mega bit per second or greater.

In a specific embodiment, the present invention provides a method for distributing data signals over power line and coaxial networks, e.g., cable TV lines. In a specific embodiment, the method includes coupling an OFDM communication signals having a data rate of about 200 Mbps and greater to one or more inductive coupling devices. In a specific embodiment, the one or more coupling devices is configured to couple a signal having a frequency of about 4 MHz to about 21 MHz and greater, but can be others. In a specific embodiment, the method includes transmitting one or more first OFDM signals derived from the OFDM signals from the one or more inductive coupling devices to one or more power lines. Each of the one or more power lines is configured to supply a voltage of about 100 volts and greater at a predetermined frequency. In a preferred embodiment, the one or more power lines provides power requirements for a house, building, apartment, or other structure or application. In a specific embodiment, the present method includes transmitting one or more second OFDM signals derived from the OFDM signals from the one or more inductive coupling devices to one or more coaxial cables. Each of the cables is configured to form a closed loop circuit comprising an inner conductor of each of the cables and an outer shield of each of the cables according to a specific embodiment. In a specific embodiment, the method includes maintaining the one or more coaxial cables substantially free from analog or digital cable television signals during a portion of time (or entirety of time) that the one or more second OFDM signals are being transmitted to provide a substantially interference-free signals from the one or more second OFDM signals. In a specific embodiment, the method includes deriving a data signal (e.g., Ethernet) from the one or more second OFDM signals for display on a display device coupled to the one or more coaxial cables. Of course, there can be other variations, modifications, and alternatives.

In still an alternative specific embodiment, the present invention provides a method for a network interface module. The method includes receiving computer network data signals in an Ethernet interface portion of the network interface module. The method also includes determining powerline network data signals in response to the computer network data signals in a computer network interface portion of the network interface module. In a specific embodiment, the method includes simultaneously providing the powerline network data signals to a coax interface portion of the network interface module and to a powerline interface portion of the network interface module.

One or more benefits can be achieved using the present invention over conventional techniques. The present invention can be applied using conventional components from computer networking and hardware technologies. Additionally, the invention can be applied to pre-existing power line and cable television network structures without substantial modification. Preferably, the present system and method are easy to implement and also allows for power line networking capabilities over a coaxial cable and powerline networkusing the same apparatus according to a specific embodiment. Depending upon the embodiment, one or more of these benefits may exist. For example, according certain embodiments, network structure is implemented using existing powerlines and coaxial cable in a same location, thereby increasing flexibility, performance, and reliability of the network infrastructure. These and other benefits have been described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of a power line system according to an embodiment of the present invention;

FIG. 1A is a simplified diagram of a coax cable according to an embodiment of the present invention;

FIG. 2 is a simplified diagram of a set-top box according to an embodiment of the present invention.

FIG. 3 is a simplified block diagram of powerline to coaxial cable gateway system 300 according to a specific embodiment.

FIG. 4 is a simplified diagram illustrating a coupler device according to an embodiment of the present invention.

FIG. 5 is a simplified block diagram of a power line module provided in the housing according to an embodiment of the present invention.

### DETAILED DESCRIPTION OF THE INVENTION

The present invention relates generally to power line networking techniques. More particularly, the invention provides a method and apparatus for power line communications or the like. Merely by way of example, the invention has been applied to a network structure that includes powerline local network over coaxial cable, but it would be recognized that other applications exist. The other applications may include any other that may have multiple power supply panels and powerline-to-coaxial interfaces, which are operable in regions with selected regions of use, e.g., apartment, hotel, office, hospital, plant.

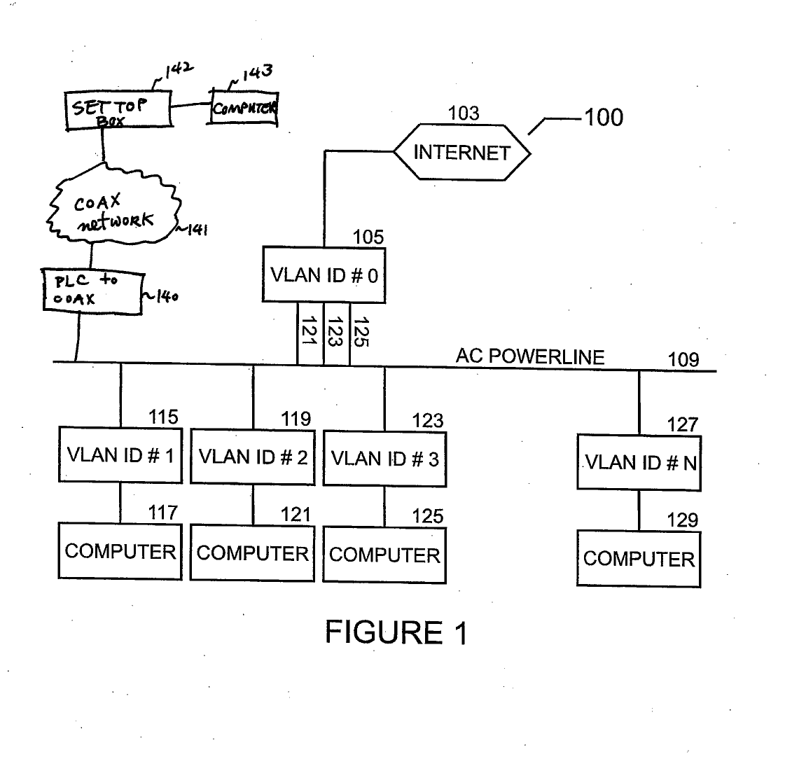

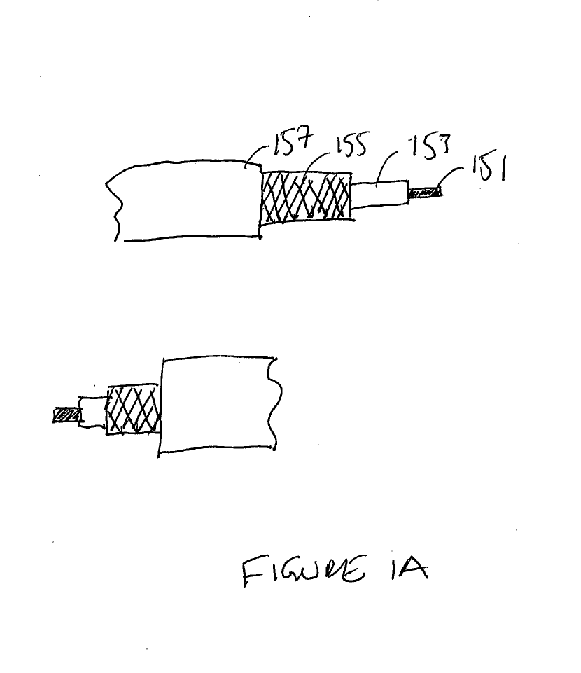

FIG. 1 is a simplified diagram of a power line system according to an embodiment of the present invention. This diagram is merely an example, which should not unduly limit the scope of the claims herein. One of ordinary skill in the art would recognize many variations, alternatives, and modifications. As shown, the system 100 for power line networking is included. The system 100 has an external data source 103, which is derived from a world wide networks of computers. As merely an example, the data source can be the Internet or other like entity. In a specific embodiment, the data source includes an ADSL modem receiving signals from network connection, but can be others. The system includes a first power line 121, a second power line 123, and a third power line 125, each of which corresponds to a phase. Each of the power lines is often bundled together and represented by reference numeral 111. Of course, there can be other variations, modifications, and alternatives.

The system 100 includes a gateway 105 coupled between the data source and an AC power line 109 according to a specific embodiment. The AC power line couples to a plurality of power line devices 115, 119, 123, 127 numbered from 1 through N, where N is an integer greater than 2, according to a specific embodiment. In addition, the AC power line is coupled to a coax converter module 140 according to a preferred embodiment. Each of the power line devices 115, 119, 123, 127 devices is coupled to a client device 117 or a plurality of client devices to define a “segment” on the power line network. As shown, power line device 119 couples to client device 121. Power line device 123 couples to client device 125. Power line device 127 couples to client device 129. Depending upon the specific embodiment, the client device can be a personal computer, a wireless device, a lap top computer, an Internet phone, an Internet appliance (e.g., refrigerator, stereo, television set, clock, digital paintings), any combinations of these, and others. Of course, one of ordinary skill in the art would recognize. Further details of the gateway and power line device can be found throughout the present specification and more particularly below.

In a specific embodiment, the coax converter module 140 is configured to convert signals from the power line 109 and couple the signals to a coax cable network 141. In a specific embodiment, the converter module 140 includes signal processor which is able to transmit data through the coax cable network 141 at a speed of 200 Mbps or faster. For example, the coax cable network 141 consists essentially of existing cable network, which may also be used for transmitting cable TV signal. As merely an example in FIG. 1A, the coax or coaxial cable has a round conducting wire 151, surrounded by an insulating spacer 153, surrounded by a cylindrical conducting sheath 155, usually surrounded by a final insulating layer 157, which is often called a jacket. In a specific embodiment, such cable can be configured to carry high frequency signals. In a specific embodiment, the powerline network connects the conducting wire to the conducting sheath to form a continuous electrical circuit loop to serve as a medium for transmission of data signals for power line communications. In a preferred embodiment, the coaxial cable is configured to transmit only powerline signals and is substantially free from any other signals such as cable television signals, which are either blocked or non-existent. It is to be appreciated that the coax cable network 141 provides an alternative structure that compliments the powerline network, thereby improving the reliability and efficiency of the system 100. The coax cable network 141 is connected to a set-top box 142. According to embodiments, the set-top box 142 is configured to, among other things, convert signals from the coax cable network 141 and provide Internet connection to various network devices, such as personal computer, IP phone, etc. In a specific embodiment, the set-top box 142 include a signal processor for performing the conversion. Depending on the application, the set-top box 142 may include various types of interfaces for coupling to network devices. For example, interfaces include RJ-45 interface, RJ-11 interface, wireless interface, etc.

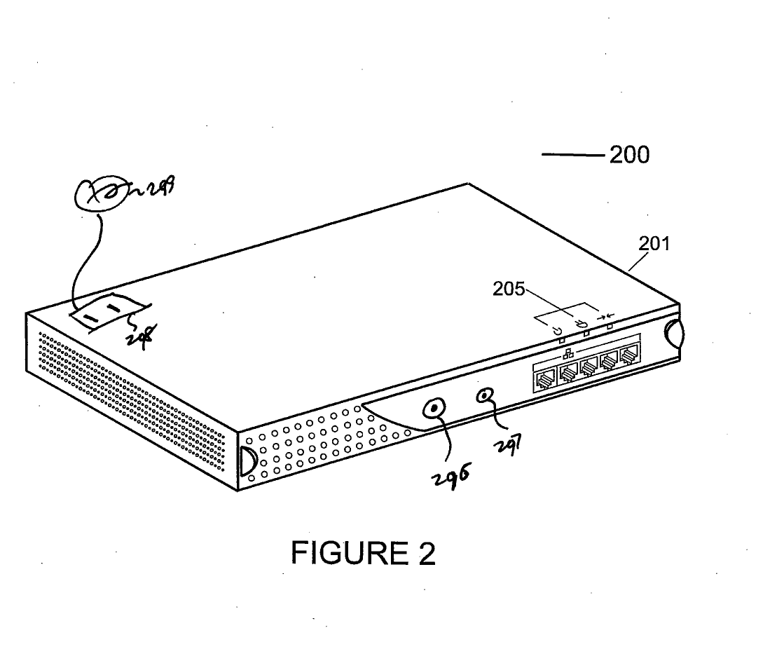

FIG. 2 is a simplified diagram of a set-top box 200 according to an embodiment of the present invention. This diagram is merely an example, which should not unduly limit the scope of the claims herein. One of ordinary skill in the art would recognize many variations, alternatives, and modifications. As an example, the set-top box 200 corresponds to the box 143 illustrated in FIG. 1. As shown, the box 200 has a housing 201 including at least three network ports 205 and coax ports 296 and 297. According to various embodiments, the box 200 includes one or more signal processor inside the box for converting signals received from the coax port 296. For example, the box 200, including signals processors, is configured to receive and convert signal at a rate of 200 Mbps or higher. The network ports 205 are used to interface with network devices, such as personal computer, IP phone, PDA, etc. In a specific embodiment, the set-up box 200 provides video signal to various display using the coax port 297. For example, the coax port 297 provides video content from a network source.

In a specific embodiment, the video content can be derived from Internet Protocol Television, commonly called IPTV. In a specific embodiment, IP can include streaming or life broadcasts or unicasts, stored video, or any combination of these. In a specific embodiment, stored video includes Video on Demand, commonly called VOD. In a specific embodiment, IPTV often includes a playback feature, which can be accomplished using the set top box, which is coupled to the TV monitor or other type of display device. In a specific embodiment, video content can be compressed using either a MPEG-2 or a MPEG-4 (e.g., H.264 codec) codec and transmitted in an MPEG transport stream using IP for broadcast or unicast according to a specific embodiment. Depending upon the embodiment, one or more standards can be used such as IGMP version 2 for connecting to a multicast stream, VOD using the Real Time Streaming Protocol (RTSP), NPVR (network-based Private Video Recorder), Network Personal Video Recording, which is a consumer service where real-time broadcast television, and others. Of course, there can be other variations, modifications, and alternatives.

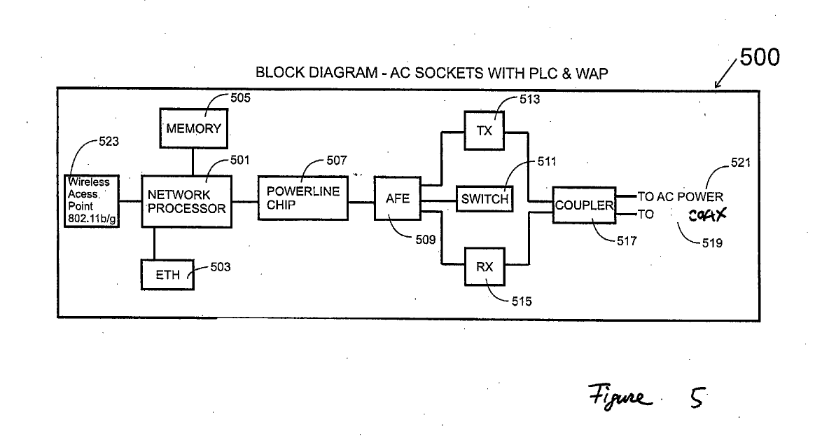

The box 200 is connected to an AC outlet 299 via the power connector 298 according to a specific embodiment. Among other things, the box 200 receives power from the AC outlet 299 for operation. According to certain embodiments, the AC outlet 299 is connected to a powerline communication network. For example, the box 200 is connected to network via both the power connected 298 and the coax port 296. In a specific embodiment, details of the set top box can be found throughout the present specification and more particularly in reference to FIG. 5, as an example. Details of the gateway are provided below.

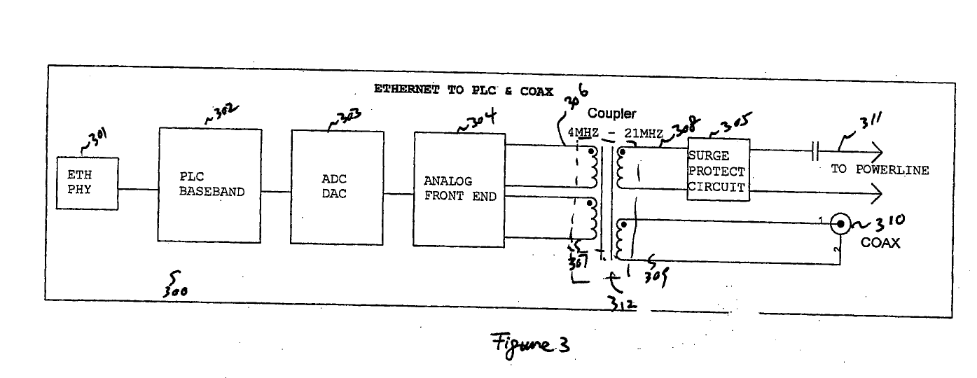

FIG. 3 is a simplified block diagram of powerline to coaxial cable gateway system 300 according to a specific embodiment. This diagram is merely an example, which should not unduly limit the scope of the claims herein. One of ordinary skill in the art would recognize many variations, alternatives, and modifications. The system 300 includes the following components:

1. a data connection 301;

2. a powerline module 302;

3. an ADC/DAC converter 303;

4. an analog front end (AFE) 304;

5. a coupler device 312;

6. a surge protector 305;

7. a coax interface 310; and

8. a powerline network 311.

The data connection 301 is configured to provide digital data connection. In a preferred embodiment, the data connection includes input/output port that couples to a data network. For example, the data network includes a wide area network and/or world wide area network, as noted. As another example, the data network also includes one or more local area networks.

The powerline module 302 is coupled to the input/output port of the data connection 301. In a specific embodiment, the powerline module 302 includes a housing, a data port, a memory, a network processor, and a powerline chip. For example, the network processor position within the housing and coupled to a power line signal via the powerline chip. In a specific embodiment, the network processor includes a network connector input/output port coupled the data connection 301. The network processor has an interface to a memory device 204, which can include a dynamic random access memory, static random access memory, or other types, depending upon the specific embodiment. As merely an example, the network processor can be any suitable type such as the ADM5120 Series manufactured by Infineon Technologies AG of Germany, but can also be others. For example, the network processor is capable of processing data at a rate of 200 Mbps or higher. In a specific embodiment, the network processor converts signals received from the data connection to a format that is suitable for transmission in a powerline communication network. In an embodiment, the powerline module 302 has a power module, which provides suitable power (e.g., voltage/current) to each of the elements described herein. Of course, one of ordinary skill in the art would recognize other variations, modifications, and alternatives.

In a preferred embodiment, the powerline module 302 has the powerline chip (“PLC” chip), which is coupled between the network processor and the converter 303. For example, the converter 303 converts digital data from the powerline module 302 into analog signals for transmission over analog medium. In a specific embodiment, the PLC can be any suitable power line integrated circuit chips and/or chip sets. As merely an example, the power line chip is an integrated circuit chip sold under part number 5500CS manufactured by INTELLON CORPORATION of Florida. Here, the chip can be a single-chip power line networking controller with integrated MII/GPSI, USB. The chip interfaces with Ethernet interfaces, among others. In a specific embodiment, the integrated circuit chip (HDPLC using OFDM or TDMA technologies) can also be manufactured by Matsushita Electric Industrial Co., Ltd., or more commonly Panasonic or DS2 of France. Additionally, the power line chip can be subject to a standard developed by the HomePlug Powerline Alliance, Inc. of 2400 Camino Ramon, Suite 375, San Ramon, Calif. 94583. Such standard can be, for example, the HomePlug 1.0 technology, HomePlug AV, and HomePlug BPL, each of which is incorporated by reference herein, in a specific embodiment. Preferably, there is at least a 200 Mbps data rate on the power line, although others may desirable. Additional features include an Integrated 10-bit ADC, 10-bit DAC and AGC, a selectable MDI/SPI PHY management interface, general purpose 8-wire serial PHY data interface. Preferably, the signal processing uses Orthogonal Frequency Division Multiplexing (OFDM) for high data reliability, as well as adaptive channel characterization, Viterbi and block coding. In alternative embodiments, the power line device can also include other chip designs that are suitable for the present methods and systems. Of course, one of ordinary skill in the art would recognize other variations, modifications, and alternatives.

The converter 303 is connected to the AFE module 303. The AFE module 303 interfaces between the chipset and the coupler device 312 according to a specific embodiment. For example, the AFE module 303 and coupler device 3120 are connected through transmit and receive devices according to an embodiment. According to embodiments, the AFE module 303 is configured to condition the second signal for transmission over one or more power line and/or one or more coaxial cables. Of course, there can be other variations, modifications, and alternatives.

The coupler device 312 includes multiple interfaces 306, 307, 308, and 309. For example, the coupler devices 312 simultaneously couples the AFE 204 to both the powerline network 311 and the coax interface 310. In a specific embodiment, the coupler device 312 is configured for coupling at a frequency of about 4 MHz to about 21 MHz. In a specific embodiment, the coupler is selected in size and shape to optimally couple the powerline signal from the powerline module via the AFE to either or both powerlines and/or coaxial cables or the like. Of course, there can be other variations, modifications, and alternatives.

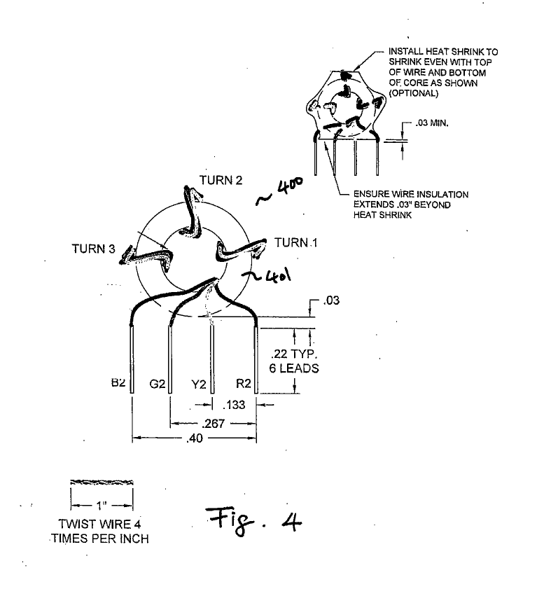

FIG. 4 is a simplified diagram illustrating a coupler device according to an embodiment of the present invention. This diagram is merely an example, which should not unduly limit the scope of the claims. One of ordinary skill in the art would recognize many variations, alternatives, and modifications. For example, the coupler device 400 is the same as the coupler device 312. The coupler device 400 includes an inductor 401 and twisted wires. According to a specific embodiment, the twisted wires are twisted against respectively intertwined with powerline and/or coaxial cables. As merely an example, which should not be limiting, the coupler is inductive. The coupler is made of a Ferroxcube, which is manufactured by Yageo Corp. of El Paso, Tex., but can be others. Additionally, the twisted wires, which are twisted to reduce interference effects and enhances signal strength, can be 28 AWG solid wire, but can be others. Such wires can be coupled to the power lines and/or coaxial cables. In a specific embodiment, the wires/coupler have a working temperature from about −20 Degrees Celsius to about 80 Degrees Celsius, but may be others, depending upon the embodiment. In other embodiments, capacitive couplers may also be used depending upon the application. Further, as shown, multiple powerline and/or coax cables may be coupled by the coupler device. And in certain embodiment, multiple coupler devices may be used. It is to be understood that other method and/or devices of coupling is possible within the spirit of the present invention.

Now referring back to FIG. 3. The powerline network 311 includes one or more powerlines. Depending on the application, the powerline network 311 may be operating at various voltage levels. For example, the powerline network 311 is capable of transmitting power having a voltage ranging from about 100 volts to 240 volts. According to embodiments, the first powerline network being adapted to transmit the second signal in various signal formats, such as OFDM signal format, block coding, etc. In a specific embodiment, the OFDM signals propagate through portions of the coaxial cable free from any interference from any cable television signals such as digital or analog cable. In a preferred embodiment, the digital or analog cable television signals are turned off or blocked to prevent any interference on the powerline signals. Of course, there can be other variations, modifications, and alternatives.

In a specific embodiment, the surge protector 305 interfaces between the powerline network 311 and the coupler. It is to be appreciated that the surge protector 305 shields the powerline network 311 from certain types of unwanted noises and/or interferences. In a specific embodiment, the surge protect substantially prevents any voltage spikes and/or current surges exceeding about 10 percent or more from a standard level to prevent any damage to any of the powerline integrated circuits and the like. That is, such circuits are often made using CMOS technologies, which are often sensitive to abrupt changes in voltage and/or current. Of course, there can be other variations, modifications, and alternatives. Additionally, the protection device can be used along with other suitable techniques to prevent damage to the powerline modules.

The coax interface 310 is connected to a coax network. According to an embodiment, the coax network is restricted for local area communication and is insulated from other coax networks (e.g., cable company coax network, neighboring coax network, etc.). In a specific embodiment, the coax network carries only data signals provided by powerline network and is free from television signals. For example, the coax network is free from interferences of television signals. Preferably, the coax network is adopted to transmit the signal in an OFDM signal format. For example, the data rate can be 200 mega bit per second or greater. As noted, the coaxial cable includes a circuit loop consisting of the inner core and outer shield, which are connected together. In a specific embodiment, the one portion of the cable transmits signals and the other portion of the cable receives the signals to form the circuit loop. Of course, there can be other variations, modification, and alternatives.

FIG. 5 is a simplified block diagram of one or more components in a set top box according to an embodiment of the present invention. This diagram is merely an example, which should not unduly limit the scope of the claims herein. One of ordinary skill in the art would recognize many variations, alternatives, and modifications. In a preferred embodiment, the components including the powerline module are provided within a interior region of the housing. Further details of the present set top box are provided throughout the present specification and more particularly below.

As shown, the set top box has a network processor 501 within the housing and coupled to the power line signal via power line chip 507 or module. In a specific embodiment, the network processor includes one or more input/output ports for one or more local area networks via line or lines 521. In a specific embodiment, the local area network can be Ethernet and/or other like technology. The network processor has an interface to a memory device 505, which can include a dynamic random access memory, static random access memory, or other types, depending upon the specific embodiment. As merely an example, the network processor can be any suitable type such as the ADM5120 Series manufactured by Infineon Technologies AG of Germany, but can also be others. Of course, one of ordinary skill in the art would recognize other variations, modifications, and alternatives.

In a preferred embodiment, the system has the power line chip 507, called herein “PLC” chip, which is coupled between the network processor and an analog front end 509 device. As shown, the PLC is coupled to the analog front end (AFE) device and/or module. The AFE module interfaces between the PLC chip and a phase coupler 519 according to a specific embodiment. Between the AFE and coupler is transmit 513 and receive 515 devices according to a specific embodiment. A switching device 511 couples to the AFE chip and transmit device according to a specific embodiment. Further details of the power line chip, AFE, TX/RX devices, and coupler are provided throughout the present specification and more particularly below.

In a specific embodiment, the power line device can be any suitable power line integrated circuit chips and/or chip sets. As merely an example, the power line chip is an integrated circuit chip sold under part number 5500CS manufactured by INTELLON CORPORATION of Florida. Here, the chip can be a single-chip power line networking controller with integrated MII/GPSI, USB. The chip interfaces with Ethernet interfaces 505, among others. Preferably, there is at least a 80 Mbps data rate or higher such as 200 Mbpson the power line, although others may desirable. In a specific embodiment, the integrated circuit chip (HDPLC using OFDM or TDMA technologies) can also be manufactured by Matsushita Electric Industrial Co., Ltd., or more commonly Panasonic or DS2 of France. Additionally, the power line chip can be subject to a standard developed by the HomePlug Powerline Alliance, Inc. of 2400 Camino Ramon, Suite 375, San Ramon, Calif. 94583. Such standard can be, for example, the HomePlug 1.0 technology, HomePlug AV, and HomePlug BPL, each of which is incorporated by reference herein, in a specific embodiment.

Additional features include an Integrated 10-bit ADC, 10-bit DAC and AGC, a selectable MDI/SPI PHY management interface, general purpose 8-wire serial PHY data interface. Preferably, the signal processing uses Orthogonal Frequency Division Multiplexing (OFDM) for high data reliability, as well as adaptive channel characterization, Viterbi and block coding. In alternative embodiments, the power line device can also include other chip designs that are suitable for the present methods and systems. Of course, one of ordinary skill in the art would recognize other variations, modifications, and alternatives.

In a specific embodiment, the coupler 517 can be any suitable device capable of injecting and/or receiving power line signals to and/from a power line, which is coupled to a power line network. In a specific embodiment, the coupler can be an inductive coupler and/or capacitive coupler, but may be others. As merely an example, the coupler (either inductive and/or capacitive coupler), but can be others. The coupler couples to AC power line 521, which is provided on the powerline network. Additionally, the coupler or other coupling device is coupled to an coax cable network 519. Of course, there can be many variations, modifications, and alternatives.

In a specific embodiment, the network processor is also coupled to wireless access point device 523. The wireless access point device can be any suitable integrated circuit chip and/or chips, including modules, according to a specific embodiment. The wireless access point device can be an 802.11-type device or other type of wireless transmission/receive device according to a specific embodiment. The wireless access device is coupled to the wireless antenna according to a specific embodiment. Of course, there can be other variations, modifications, and alternatives.

According to an embodiment, the present invention provides a powerline communication system. The system includes a data connection that is configured to communicating a first signal in a first format. The data connection includes an input/output port. The system also includes a powerline module coupled to the input/output port of the data connection. The powerline module has a data port. The powerline module is configured to convert the first signal in the first format into a second signal into a second format. The first format is different from the second format. The system additionally includes an analog front end device that coupled to the dataport of the powerline module. The analog front end device is configured to condition the second signal for transmission over one or more powerline and/or one or more coaxial cables. Furthermore, the system includes a coupler device coupled to the analog front end device. The coupler device is configured for coupling at a frequency of about 4 MHz to about 21 MHz. The system also includes a first powerline network that includes substantially one or more powerlines. The first powerline network is coupled to the analog front end device using the coupler device. The set of the powerlines is capable of transmitting power having a voltage ranging from about 100 volts to 240 volts. The first powerline network is adapted to transmit the second signal in an OFDM signal format. The system further includes a coax cable free from a television signal coupled to the analog front end device using the coupler device. For example, the coax cable is adopted to transmit the second signal in an OFDM signal format at a data rate of about 200 mega bit per second or greater. For example, the embodiment is illustrated according to FIG. 3.

One or more benefits can be achieved using the present invention over conventional techniques. The present invention can be applied using conventional components from computer networking and hardware technologies. Additionally, the invention can be applied to pre-existing power line structures without substantial modification. Preferably, the present system and method are easy to implement and also allows for power line networking capabilities and power plug abilities using the same apparatus according to a specific embodiment. Depending upon the embodiment, one or more of these benefits may exist. For example, according certain embodiments, network structure is implemented using existing powerlines and coaxial cable in a same location, thereby increasing flexibility, performance, and reliability of the network infrastructure. These and other benefits have been described throughout the present specification and more particularly below.

It is also understood that the examples and embodiments described herein are for illustrative purposes only. As an example, the embodiments have been shown using OFDM signals. Other signals may also be used. Additionally, the embodiments have been used using a conventional cable network, but other networks can also replace the cable networks. Furthermore, it should be preferred to stop and/or block substantially all of the cable TV signals including digital or analog to prevent any interference with the powerline networking signals, which will be converted into, for example, Ethernet. It would be appreciated that various modifications or changes in light thereof will be suggested to persons skilled in the art and are to be included within the spirit and purview of this application and scope of the appended claims.

What is claimed is:

1. A powerline communication system comprising:
a data connection being configured to communicating a first signal in a first format, the data connection comprising an input/output port;
a powerline module coupled to the input/output port of the data connection, the powerline module having a data port, the powerline module being configured to convert the first signal in the first format into a second signal into a second format, the first format being different from the second format;
an analog front end device coupled to the dataport of the powerline module, the analog front end device being configured to condition the second signal for transmission over one or more powerline and/or one or more coaxial cables;
a coupler device coupled to the analog front end device, the coupler device being configured for coupling at a frequency of about 4 MHz to about 21 MHz;
a first powerline network comprising substantially one or more powerlines, the first powerline network being coupled to the analog front end device using the coupler device, a set of the powerlines being capable of transmitting power having a voltage ranging from about 100 volts to 240 volts, the first powerline network being adapted to transmit the second signal in an OFDM signal format; and
a coax cable free from a television signal coupled to the analog front end device using the coupler device, the coax cable being adopted to transmit the second signal in an OFDM signal format at a data rate of about 200 mega bit per second or greater.

2. The system of claim 1 further comprising a set-top box, the set-top box being comprising:
a coax cable interface, the coax cable interface being coupled to the the to coax cable;
a network interface, the network interface being configured provide data connection.

3. The system of claim 2 wherein the network interface comprises an RJ-45 connector.

4. The system of claim 2 wherein the set-top box further comprises a network processing module.

5. The system of claim 1 wherein the powerline module comprises an analog to digital converter.

6. The system of claim 1 wherein the first powerline network comprises a surge protector.

7. The system of claim 1 wherein the first format is comprises an ADSL format.

8. The system of claim 1 further comprising a surge protection device.

9. The system of claim 8 wherein the surge protection device shield noises.

10. The system of claim 1 wherein the input/output port is bi-directional.

11. The system of claim 1 wherein the data connection comprises an ADSL modem.

12. The system of claim 1 wherein the data connection comprises a cable modem.

13. A powerline communication system comprising:
a coax cable carrying a first signal in a first format, the first signal being free from television signal, the first signal being characterized by a data rate of about 200 Mbps and greater, the first format being associated with a first format;
a coupler device being coupled to the coax cable, the coupler device being configured for coupling at a frequency of about 4 MHz to about 21 MHz;
an analog front end device coupled to the coupler device, the analog front end device being configured to receive the first signal and to condition the first signal for transmission over a powerline network;
a powerline module coupled to the analog front device, the power line module having a data port, the powerline module being configured to convert the first signal to a second signal in a second format, the second format being different from the first format; and
a data connection being configured to transmit the second signal to a network device using an input/output port.

14. The system of claim 13 wherein the network device comprises a computer.

15. The system of claim 13 wherein the network device comprises an ADSL modem.

16. The system of claim 13 wherein the powerline module comprises a powerline integrated circuit chip.

17. A method for a network interface module comprises: receiving computer network data signals in an Ethernet interface portion of the network interface module;
determining powerline network data signals in response to the computer network data signals in a computer network interface portion of the network interface module; and
simultaneously providing the powerline network data signals to a coax interface portion of the network interface module and to a powerline interface portion of the network interface module.

18. A method for distributing data signals over power line and coaxial networks, the method comprising:
coupling an OFDM communication signals having a data rate of about 200 Mbps and greater to one or more inductive coupling devices, the one or more coupling devices being configured to couple a signal having a frequency of about 4 MHz to about 21 MHz and greater;
transmitting one or more first OFDM signals derived from the OFDM signals from the one or more inductive coupling devices to one or more power lines, each of the one or more power lines being configured to supply a voltage of about 100 volts and greater at a predetermined frequency; and
transmitting one or more second OFDM signals derived from the OFDM signals from the one or more inductive coupling devices to one or more coaxial cables, each of the cables being configured to form a closed loop circuit comprising an inner conductor of each of the cables and an outer shield of each of the cables;
maintaining the one or more coaxial cables substantially free from analog or digital cable television signals during a portion of time that the one or more second OFDM signals are being transmitted to provide a substantially interference-free signals from the one or more second OFDM signals; and
deriving a data signal from the one or more second OFDM signals for display on a display device coupled to the one or more coaxial cables.

19. The method of claim 18 wherein the first one or more OFDM signals and second one or more OFDM signals are transferred simultaneously during a predetermined time period.

20. The method of claim 18 wherein the second one or more OFDM signals comprise streaming video information.
